(19) United States
(12) Patent Application Publication
(10) Pub. No.: US 2024/0410840 A1
(43) Pub. Date: Dec. 12, 2024

(54) DETERMINATION OF THE SPATIAL DISTRIBUTION OF RADIATION DAMAGE IN HETEROGENEOUS MATERIALS

(71) Applicant: NEWSOUTH INNOVATIONS PTY LIMITED, Sydney, New South Wales (AU)

(72) Inventors: Patrick BURR, Sydney, New South Wales (AU); Matthew BRAND, Sydney, New South Wales (AU)

(21) Appl. No.: 18/694,761

(22) PCT Filed: Sep. 27, 2022
(86) PCT No.: PCT/AU2022/051156

§ 371 Date: Mar. 22, 2024

(30) Foreign Application Priority Data
Sep. 28, 2021 (AU) 2021903104

(51) Int. Cl. G01N 23/18; G01N 23/04; G06T 7/00

(52) U.S. Cl. CPC G01N 23/18; G01N 23/04; G06T 7/0002; G01N 2223/646; G06T 2207/10024; G06T 2207/10056

(57) ABSTRACT

A method for determining a spatial distribution of a radiation damage of a heterogenous material. The steps include some or all of the following. Representing a multiphase microstructure of the heterogenous material as a 2D or 3D image. Determine a first energy of a primary knock-on atom (PKA) ion at a first interface at a first distance from an incident PKA ion to a first phase material of the microstructure image representation. Then determine a second PKA energy in a second phase across a first interface using the first PKA energy and PKA energy-depth-damage profiles of the same PKA in the bulk (isolated) materials of the parent phases. The process is repeated at subsequent interfaces. The radiation damage being determined from the PKA ion energy deposited in each phase material.

### FIELD OF THE INVENTION

The present invention relates to determining the spatial distribution of radiation damage in heterogenous materials. In particular, the invention relates to determining the spatial distribution of radiation damage in materials used in nuclear environments, such as nuclear reactors. The invention may also relate to determining radiation damage in relation to materials for radiation shielding, space applications, radiopharmaceuticals and sterilisation techniques using ionising radiation. While some embodiments will be described herein with particular reference to that application, it will be appreciated that the invention is not limited to such a field of use, and is applicable in broader contexts.

### DISCUSSION OF THE PRIOR ART

Any discussion of the prior art throughout the specification should in no way be considered as an admission that such prior art is widely known or forms part of common general knowledge in the field.

Understanding the effects of radiation damage in materials that are exposed to neutron and other radiation is important to advancing technologies and industries such as nuclear power, space exploration and radiopharmaceuticals, as well as radioactive materials handling, storage and disposal, sterilisation using radiation, non-destructive testing using radiation, and power sources reliant on radioactive materials (such as beta-voltaic, RTG and nuclear batteries). When materials are irradiated by highly energetic particles such as neutrons, photons, ions and electrons, the microstructure of the material may become radiation damaged. For example, if a high energy incident neutron impacts an atom in a material it can transfer some of its energy and the atom may be displaced from the material lattice, leaving a vacancy behind. The displaced atom, known as a as a Primary Knock-on Atom (PKA), then penetrates as a high energy ion imparting further radiation damage into the material. The PKA ion may transfer enough kinetic energy to other atoms in the lattice such that the other atoms are also displaced and leave vacancies in the material lattice. When the displaced atoms lose enough energy, they eventually come to rest and forms interstitial defects in the lattice. The amount of damage in a material is usually measured in displacements per atom (dpa).

In environments where high fluxes and energies of radiation interact with a material, such as in outer-space or nuclear reactors, the material can undergo significant changes that must be quantified and understood so that reliable performance can be achieved. For example, nuclear reactor steels exposed to neutron irradiation may have changes to hardness, strength, ductility and physical dimensions through swelling and creep.

In these radiation environments, it is often important to understand the location and amount of damage being produced, for engineering design as well as lifecycle estimates. Existing techniques to calculate radiation damage in materials assume that the material is homogeneous at the microstructural length scale, leading to overly conservative estimates, which in turn may lead to under performance and increased costs in design, construction, maintenance and operation. This assumption to material homogeneity is more problematic in advanced materials, which typically have complex and highly heterogeneous microstructures.

In heterogeneous microstructures the various phases can have very different compositions with significant differences in chemical and nuclear properties depending on the elements present, their composition and density. As a result, the irradiating particles will interact and produce damage in a different manner for each phase. The situation becomes even more complicated when interfaces between phases are taken into consideration.

None of these prior art techniques provides a satisfactory solution to determining the spatial distribution of radiation damage in microstructures of heterogenous materials. Nor to the ease of undertaking simulations rapidly to multiple design scenarios to actual or proposed heterogenous materials.

### SUMMARY OF THE INVENTION

The present invention aims to provide an alternative technique to determining the spatial distribution of radiation damage in heterogenous microstructures which overcomes or ameliorates the disadvantages of the prior art, or at least provides a useful choice.

According to a first aspect of the invention, there is provided A method for determining a spatial distribution of a radiation damage of a heterogenous material, including the steps of:
representing a geometry and a distribution of a multiphase microstructure of the heterogenous material as an image;
determine a first energy of a PKA ion at a first interface at a first distance from an incident PKA ion to a first phase material of the microstructure image representation;
use the first energy at the first interface between the first phase material and an adjacent second phase material to determine a second PKA energy at a second interface to a further phase material at a second distance from the first interface;
use the second energy at the second interface to determine a further PKA ion energy in the further phase material; and
repeat the steps for further interfaces and further phase materials across the microstructure image representation;
wherein the further phase materials are at least one of: the same as the prior phase material/s and different to the prior phase material/s; and
wherein the radiation damage in the heterogenous material is determined from the PKA ion energy deposited in each phase material;
whereby the spatial distribution of the radiation damage across the microstructure image representation is determined.

In some embodiments, the energy of a PKA ion is determined using the equation:

$$E \{ x ) = \{ \begin{matrix}{E}_{0} - max , E ( x ) > ϵ \\ {A ( d - x )}^{\frac{1}{c}} , E ( x ) \leq ϵ\end{matrix} .$$

Preferably, m is defined as

$$m = \frac{{E}_{0} - ϵ}{d - {( \frac{ϵ}{A} )}^{c}} .$$

More preferably, A is defined as

$$A = {[ \frac{{ϵ}^{c} + c {ϵ}^{c - 1} ( {E}_{0} - ϵ )}{d} ]}^{\frac{1}{c}} .$$

In some embodiments, A is defined as

$$= \frac{{E}_{0}}{{d}^{\frac{1}{c}}} if ϵ = {E}_{0} .$$

In further embodiments, the microstructure image representation is in 3D voxels or 2D pixels and the determinations to PKA ion energies and interfaces are made voxel by voxel, or pixel by pixel.

Preferably, the step of representing a geometry and a distribution of a multiphase microstructure further includes multiple images to determine a three dimensional spatial distribution of radiation damage. More preferably, the microstructure geometries are in the order of the longest-range PKA produced by the material in the radiation field.

In some embodiments, the geometry and the distribution of a multiphase microstructure are derived from an actual heterogenous material. In other embodiments, the geometry and the distribution of a multiphase microstructure are hypothesised for any arbitrary hypothetical material.

In yet further embodiments, the spatial distribution of radiation damage is calculated deterministically or stochastically.

In accordance with a second aspect of the present invention, there is provided a method for determining a spatial distribution of a radiation damage of a heterogenous material, including the steps of:
representing a geometry and a distribution of a multiphase microstructure of the heterogenous material as an image;
determine the energy spectrum of PKA ions at a first interface at a first distance from an incident PKA ion to a first phase material of the microstructure image representation;
use the first energy spectrum at the first interface between the first phase material and an adjacent second phase material to determine a second PKA energy spectrum at a second interface to a further phase material at a second distance from the first interface;
use the second energy at the second interface to determine a further PKA ion energy spectrum in the further phase material; and
repeat the steps for further interfaces and further phase materials across the microstructure image representation;
   wherein the further phase materials are at least one of: the same as the prior phase material/s and different to the prior phase material/s; and
   wherein the radiation damage in the heterogenous material is determined from the PKA ion energy deposited in each phase material;
   whereby the spatial distribution of the radiation damage across the microstructure image representation is determined.

In accordance with a second aspect of the invention, there is provided a material radiation damage spatial distribution of a microstructure according to any of the above aspects.

In accordance with a third aspect of the invention, there is provided material property of a microstructure as derived from a radiation damage spatial distribution according to any of the above aspects.

In accordance with a fourth aspect of the invention, there is provided a strategy to reduce radiation damage to material, or increase material resistance to radiation damage, derived from the spatial distribution of radiation damage according to any of the above aspects.

Further forms of the invention are as set out in the appended claims and as apparent from the description.

### BRIEF DESCRIPTION OF THE DRAWINGS

The description is made with reference to the accompanying drawings, of which:

FIG. 1 is a TEM image of a material;

FIG. 2 is a colourmap image of the material shown in FIG. 1;

FIG. 3 is a schematic diagram of the damage process in materials due to PKAs;

FIG. 4 is a further schematic diagram of the damage process in materials due to PKAs;

FIGS. 5A to 5D are schematic graphs of dpa per PKA radiation damage versus depth for an example material (FeNiAl) according to an application of one embodiment of the invention.

FIGS. 6A to 6D are schematic diagrams showing the steps of the radiation damage process across material interfaces;

FIGS. 7A and 7B are graphs of calculated PKA ion spectra for neutron damage to example materials according to an embodiment of the present invention.

### DETAILED DESCRIPTION

When radiation particles (neutrons or charged ions) interact with materials they cause damage. For ions, the damage to the material has been previously quantified using binary collision approximation (BCA) calculations. A brief summary of BCA and other prior art techniques and packages/programs/codes is provided at the end of the Detailed Description section as background to the following description. For neutrons, the NRT (Norgett-Robinson-Torrens) model, or in its simpler form the Kinchin-Pease model, may be used to quantify the damage. Normally when computing the damage rates of a complex material such as steels and other engineering alloys, a crude assumption is made that the material is homogeneous with some nominal composition so that the NRT formula can be used. Only the bulk properties and elemental compositions are considered in the calculations and microstructural features such as the presence, density and distribution of secondary phases are ignored. This is problematic, especially in the case of composites or materials with significant amounts of secondary phases. The different nuclear and chemical properties of the differing phases can significantly alter the type, strength and spatial extent of the radiation damage that occurs.

The way in which neutrons cause damage to materials is by producing energetic PKA ions which then proceed to interact with and damage the material in collision cascades. This therefore makes it amenable to alternatively determine the damage produced by neutrons indirectly using a BCA package coupled with information about the energy spectrum of these PKA ions. However, assumptions to material homogeneity are still an issue when using BCA packages.

These BCA, NRT and other models/packages are all mature prior art technologies but still retain the underlying assumption that the material is homogenous. However, most in-use materials are often highly heterogenous in microstructure with multiple phases. Accordingly, prior art predictions with these packages for heterogenous material may be either overly or under-conservative as well as computationally burdensome.

Previously, the only method of accounting for heterogeneity with packages such as BCA, NRT and the like was to treat each phase separately in isolation. However, treating each phase separately in isolation does not account for radiation damage interactions across the interface between the two phases. That is, PKA ions and cascade particles from one phase enter and damage a neighbouring phase and vice versa.

How radiation damage is created or propagated at an interface between two materials is the subject of fundamental scientific research, with limited consensus. In the fundamental research field of radiation damage in materials, atomic-scale simulation tools such as Molecular Dynamics are used. Such high-resolution simulations provide relatively accurate results to the dynamics down to a scale of a few or less nanometres (nm) and very short times (in the order of ns), for a specific scenario such as a selected pair of phases of a heterogenous material, with a specific interface type (e.g. coherent, semi-coherent, etc) and specific crystal orientation. Additionally, Monte-Carlo Neutronics (MCN) codes may also be used to quantify damage. These codes track all particles, collisions and displacements caused by an irradiating flux in a material at microstructural length scales. However, the required expertise, computational resources and processing time is very high for such fundamental simulations as they are tools to further fundamental understanding of radiation-matter interaction in contrast to such packages as BCA and NRT. For engineering design processes and metallurgical material evaluations, rapid and more easily used simulations are required. This is required both at the materials design and prototyping stage as well to inform maintenance schedules and assess the life cycle of components exposed to radiation.

In order to take the geometrical phase structure and distributions of the phases into account, the inventors have devised a new and inventive technique for actual microstructures as well as proposed microstructures for heterogenous materials. The technique identified and formulated by the inventors determines the spatial distribution of radiation damage production in heterogenous materials, specifically in multiphase materials with interfaces. The technique provides information on damage production rates to heterogenous materials, taking into account interfaces, morphologies and chemical heterogeneities. This information is critically important when designing new alloys that are more radiation resistant or radiation tolerant, and to assess the degree of damage of a material in service in a radiation environment.

The technique extends on and addresses the deficits in the mature technologies referred to in the above and further below to enable radiation damage to be determined in heterogeneous materials. That is, the technique quantifies the degree of localisation and spatial heterogeneity of radiation damage production in actual heterogenous materials. In addition, the inventors have found that the technique is substantially faster and requires substantially less computational resources and expertise than the prior art techniques where they have been attempted with heterogenous materials. This improvement in speed and reduced computational resources is of a particular advantage during the structural design and metallurgical engineering processes to quantify where radiation damage may accumulate in heterogenous materials.

In one example, some of the most extreme neutron environments occur in nuclear power plants. In a fission nuclear reactor environment, ferritic steels are used for the reactor pressure vessels (RPV). For example, a simplified ferritic superalloy with a Fe matrix (7.85 gcm-3) and NiAl (3.47 gcm-3) precipitates has been proposed as a potential candidate for future fission reactors. Fe—NiAl is a strongly heterogeneous material with a secondary phase volume of ˜20%, and advantageously has good thermal and fatigue properties.

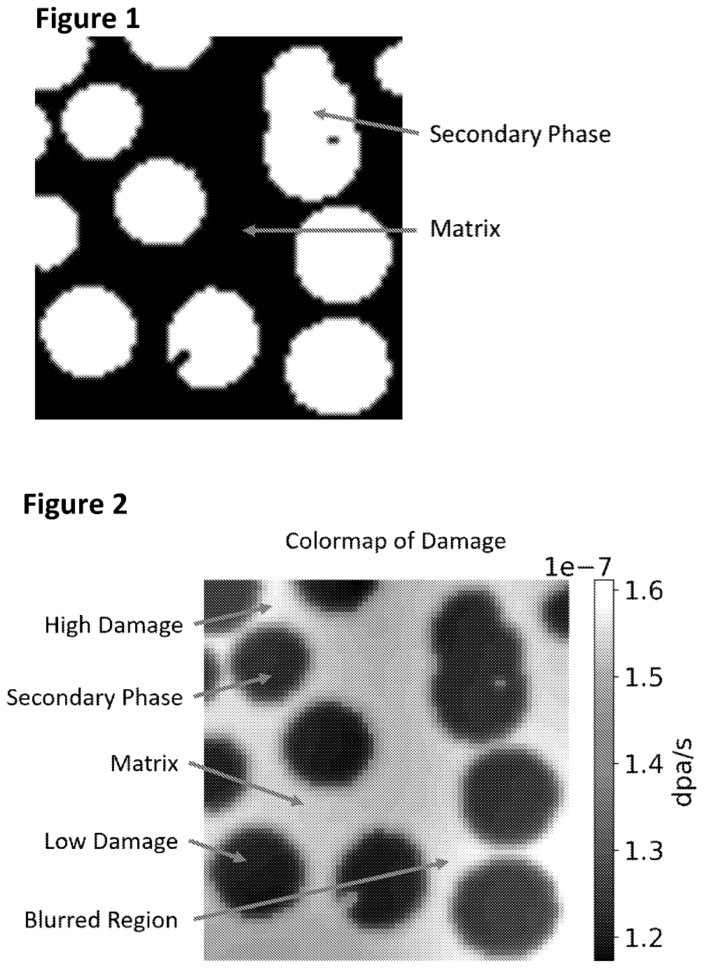

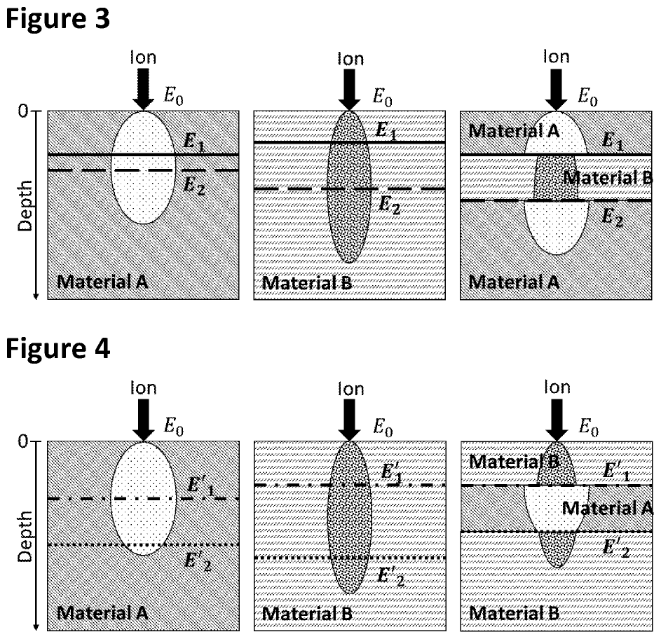

FIG. 1 is a general Transmission Electron Microscopy (TEM) image of a material, showing a matrix and secondary phase. FIG. 2 is colourmap image of the material, showing high damage and low damage regions. As can be seen from the FIG. 2, the microstructure of the heterogeneous material is in the order of 10's to 100's of nm to the geometry of the precipitates within the matrix.

In one example, in fusion nuclear reactors, the shielding materials are needed to attenuate both high energy neutron and high energy gamma radiation. A potential heterogenous material that could achieve this is a W-W2B composite as the tungsten, W (19.3 gcm-3), attenuates gamma effectively due to its large atomic number, while the boron, B, in the other phase material of W2B (17.09 gcm-3) moderates and absorbs the neutrons.

The inventors have found that prior art methods of calculating neutron damage can only be used for bulk homogenous materials as detailed above and further below. That is, the prior art cannot account for the effects of PKA ions from secondary material phases such as a precipitate entering the matrix phase and vice versa. As the PKA ion spectrum resulting from an incident neutron flux can be readily calculated, the damage can be obtained by considering the ion irradiation damage from the PKA ions. An inventive and computationally efficient technique was developed to determine the radiation damage dpa profile across multiple interfaces in a microstructure of a heterogenous material.

In brief the inventors have found that by considering the energy of the PKA ion as a function of depth and joining locations in the radiation damage dpa profiles that have the same PKA ion energies across interfaces in the microstructure, a good approximation of the damage curve can be obtained.

Applying the technique to an image representing the microstructure of a heterogeneous material, the spatial distribution as colour intensity maps of the radiation damage dpa due to a neutron flux were produced. These radiation damage maps to microstructure revealed that the neutron damage was not uniform. The inventors have found that radiation damage is heterogeneously distributed throughout the microstructure, with high and low radiation damage dpa values concentrated in separate material phases. In addition, the inventors also found there was a variation of damage within each phase that is dependent on the inter-phase spacing, with closely packed phases resulting in more averaging.

With respect to FIG. 2 further below the radiation damage profiles according to the invention are determined and detailed for the microstructure images of FIG. 1.

Radiation damage displacements within a material are primarily due to damage collision cascades initiated by the PKA ions. Each neutron from the incident, irradiating neutron flux to the material tends to only interact with at most a single atom in the region of interest due to a neutron's large mean free path. When an incident neutron collides and imparts energy to an atom in the material lattice, producing a PKA ion, this PKA ion strongly interacts with the surrounding atoms due to the electronic charges, initiating further displacements of other atoms as ion cascades from the material lattice. Those other displaced ions may also initiate collision and damage cascades in a similar manner to the initial PKA. The initial PKA ion continues to produce damage until its energy dissipates below the displacement threshold energy in the material. The amount and depth of the damage that occurs is dependent on the material composition and PKA ion energy.

The inventors have noted that when the material composition changes at an interface between one phase and a second phase of the material, the radiation damage profile changes to be substantially similar to that as if the PKA ion at the interface was incident on the pure second material, but with different incident energy. The second phase material may differ in at least one of density, atomic mass, atomic charge, molecular composition and structure, to that of the other first material or phase in the heterogenous material. The inventors have also noted that the ballistic energy T that causes radiation damage displacements in the second phase material only depends upon the energy of the PKA at the specified location:

$$T ( E , r ) = {T}_{dam , r} ( E ) \qquad ( 1 )$$

where T_{dam,r} is the BCA damage-energy profile of the specified PKA in the material at location r, and is not explicitly dependent on the location of interfaces in a composite.

That is, the radiation damage profile continues in the second pure material with a radiation profile that would be observed from energy E1 if the same PKA with initial energy E0 was produced in the second pure material, where E1 is the energy that the original PKA has, on average, when entering the second material.

Furthermore, the inventors have noted that the above considerations may be extended to the multiple interfaces present in the microstructure of multiphase heterogenous material. That is, for a second interface between the second phase material and a further phase material the transmission of the PKA ion energy at the second interface through to the further phase material can be considered analogously to the transmission of the PKA across the first interface into the second material.

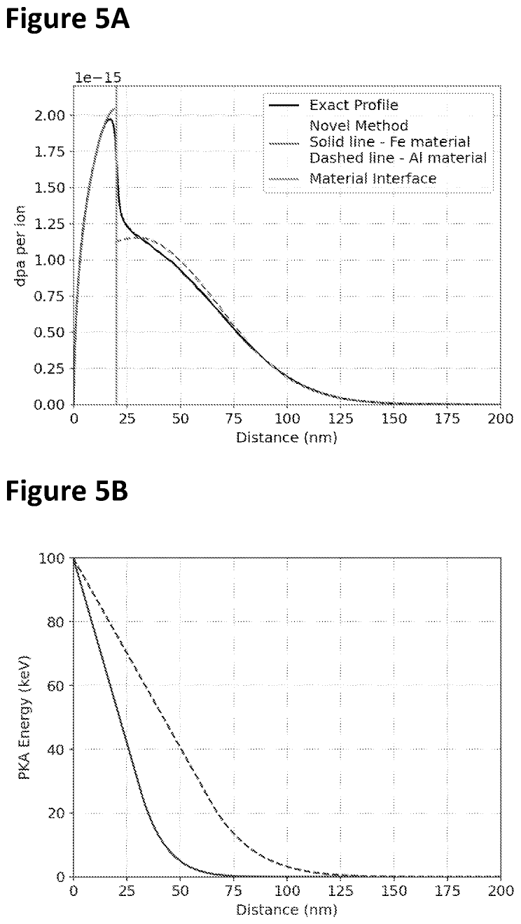

FIG. 3 is a schematic representation of the damage process in pure and composite materials due to a PKA with initial energy E0. In Material A, as the PKA travels through the material it creates a region of damage represented by the oval, the oval width being indicative of the magnitude of damage at a given depth. The PKA also looses kinetic energy as it progresses. When it reaches the solid line, it has a lower energy E1, and when it reaches the dashed line it has energy E2 with E0>E1>E2. In Material B, the same PKA enters the material. Due to the different properties of Material B, the damage extends further into the material and has a smaller magnitude at each depth compared to Material A. In Material B, the PKA also looses energy at a different rate, and the locations when the PKA has energy E1 and E2 are different to that of Material A.

In the composite material, the PKA starts by entering Material A. At the distance where the energy is E1, an interface occurs and the PKA enters Material B. Up to this point the damage region evolves as it would in Material A. At the interface the PKA enters Material B energy E1. It continues to travel through and looses energy in the Material B starting at the location of the solid, E1 line. The damage region of Material B in the composite continues as it would from the solid line in the pure material. When the PKA has reached energy E2, a second interface occurs in the composite and the PKA enters Material A again. The process just described is repeated, but the PKA starts at the dashed E2 line in Material A.

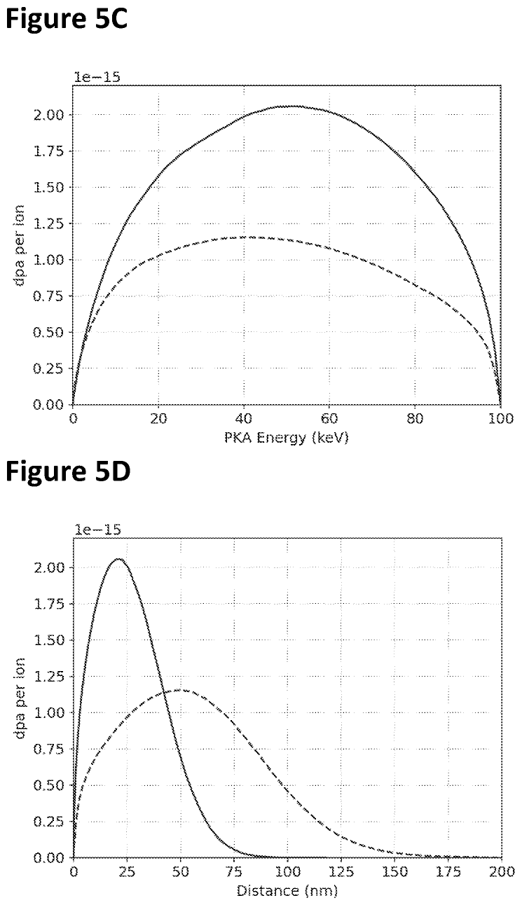

FIG. 4 shows the same scenario but with materials A and B switched. The depth of the interfaces remains the same in the composite structure. The PKA first enters Material B before traveling the same physical distance as it does in the first scenario. However as the energy loss rate is different in Material B, the PKA has a different energy E′1 (the dot-dashed lines in Materials A and B) at the interface. Similarly, at the second interface, the PKA has energy E′2 (the dotted line). As a result of the different energies at the interfaces, different damage profiles are produced in the two composite structures.

This method can be used for multiple interfaces and more than two materials.

The energy of a PKA at a given distance r from the source in an arbitrary material is not known a priori and must be found by using the energy-depth profiles described below in Equation (3). In a material with interfaces, the energy is obtained by the function ε, which makes the energy profiles continuous at all interfaces

$$y \cdot E = ε ( r , y ) \qquad ( 2 )$$

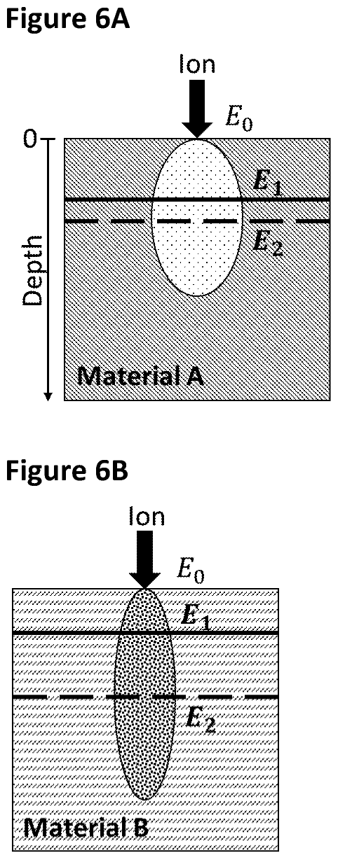

The determination of heterogenous radiation damage is described further below as exemplified with respect to Equations (2) to (5) and FIG. 5A.

In the example of FIG. 1 of an actual two phase material with a spherical second phase material within a matrix of first phase material, the further phase material is the same as the first, initial material. In FIG. 1, PKAs are produced at each and every point in the figure, and they go in each and every direction. As such, each PKA will encounter a number of interfaces before it comes to rest. In the present invention, 1D methodology presented above is applied by repeating it for each of those PKA straight-line trajectories. This is in itself a substantial innovation, as the method relies on determining the PKA trajectories in a way that a deterministic solution is obtained, as opposed to throwing PKA's at random until good statistics are achieved, as is done in Monte Carlo methods. The inventors have also noted that this technique of reducing the transmission or penetration of the PKA ion, or cascading ions, through a multiphase microstructure as a series of interfaces between pure materials can be done across a representation of the geometry and distribution of a microstructure to determine a radiation damage spatial distribution. It will be readily appreciated that this technique or method may be applied to heterogenous materials of more than two phase materials as well as any geometry or distribution of microstructure in a heterogenous material.

In the following the details to the determination of the transmission energies of the PKA ion through multiple interfaces is firstly described. Then the determination of the radiation damage profile or spatial distribution is described through each phase and their respective interfaces for a microstructure. Then the determination of the spatial distribution of radiation damage profiles for complex microstructures of actual heterogenous materials is detailed. This is provided with reference to the example of heterogenous materials used in nuclear reactors, but it will be appreciated that the invention is applicable in other contexts.

The distribution of energy as a function of depth for the PKA ion is not a standard output of BCA packages. The method of the present invention calculates the PKA energy distribution as a function of depth using BCA software. As an example, one way of obtaining it is by executing a simulation in the “Quick K-P” mode for a BCA package. A brief prior art summary to the Quick K-P mode is provided at the end of the Detailed Description. This mode only tracks the transmission or penetration of an initial PKA ion through a homogenous/pure material. The Quick K-P mode generates the amount of energy the PKA ion deposits in each calculation cell/element for the PKA ion simulated track in a homogenous material. BCA codes typically provide the deposited energy as “electronic” and “ballistic” components, the summation of which gives the total amount of energy deposited by the PKA ion at each calculation element for a depth in a material. Subtracting the cumulative sum of the PKA ion energy deposition along its track in material from the initial PKA energy Eo yields the energy profile as a function of distance or depth of penetration in a material. It will be appreciated that calculating the PLA energy distribution as a function of depth can be performed in other ways.

A reference database for a pure homogenous material of PKA ion transmission energy with penetration depth of a pure homogenous material is generated using, for example, the BCA packages as described in further detail at the end of the Detailed Description. The inventors have then found that this reference database transmission energy with depth for a material may be curve fitted with Equation (3), below, to provide a function E(x) of PKA ion energy with penetration depth x.

$$E ( x ) = \{ \begin{matrix}{E}_{0} - mx , & E ( x ) > ϵ \\ {A ( d - x )}^{\frac{1}{c}} , & E ( x ) \leq ϵ\end{matrix} \qquad ( 3 )$$

As the energy loss of the PKA must be smooth and continuous between the two regimes, m and A are given by Equations (4), (5) and (6):

$$m = \frac{{E}_{0} - ϵ}{d - {( \frac{ϵ}{A} )}^{c}} \qquad ( 4 )$$

$$A = {[ \frac{{ϵ}^{c} + c {ϵ}^{c - 1} ( {E}_{0} - ϵ )}{d} ]}^{\frac{1}{c}} \qquad ( 5 )$$

$$= \frac{{E}_{0}}{{d}^{\frac{1}{c}}} if ϵ = {E}_{0} \qquad ( 6 )$$

Where d, c and ϵ are fitting parameters, m is chosen to make the function continuous, and x is the depth into the material. If the PKA is created with an energy that immediately places it within the nuclear stopping regime, ϵ=E0 and A further reduces to Eq. (6). It is known that the deposition or decay of the PKA ion energy through a material occurs in two regimes: a linear region due to excitation of atomic atoms in the material and the PKA ion (electronic loss) and a power law region due to nuclear/“ballistic” interactions where the PKA ion displaces atoms from the material lattice. The change in regimes occurs when the particle has a reduced LSS energy of approximately ϵ=0.3, see Equation (10) at end of Detailed Description.

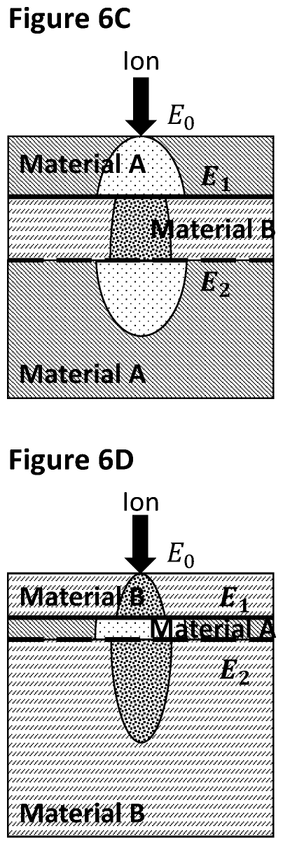

As an example of determination of E(x) functions the inventors have undertaken a simulation for iron (Fe) and aluminium (Al) with a BCA package known as IRADINA. The simulation was done for incident 100 keV Fe PKA ions, with 10,000 ions in bins of width 1 nm of the material to the incident neutron flux. FIG. 5B shows the Equation (3) E(x) fitted function for Fe and Al homogenous materials, both for the same incident Fe PKA ions. Referring to FIGS. 6A and 6B, the curve to Fe of FIG. 2(b) can be considered analogous to material 1 of FIG. 6A and the fitted curve function to Al of FIG. 5B analogous to material 2 of FIG. 6B.

The inventors have found that the radiation damage K(r) function for each uniform small volume of material (a voxel) at location r due to PKA ions of energy, E, originating from a source location r, can be determined from Equations (7) to (11) below.

$$K ( r ) = {\sum }_{{r}_{0}} {\sum }_{E} f ( r , {r}_{0} ) S ( {r}_{0} , E ) F ( r , {r}_{0} ) \qquad ( 7 )$$

$$f ( r , {r}_{0} ) = T ( ε ( \vert r - {r}_{0} \vert , y ) , \vert r - {r}_{0} \vert ) \frac{p}{l} \frac{0.8}{2 {E}_{d} ( r )} \frac{1}{N ( r ) V} \qquad ( 8 )$$

$$S ( {r}_{0} , E ) = ϕ ( {r}_{0} , E ) N ( {r}_{0} ) V \qquad ( 9 )$$

$${F}^{3 D} ( r , {r}_{0} ) = \frac{{p}^{2}}{4 π {\vert r - {r}_{0} \vert}^{2}} \qquad ( 10 )$$

$${F}^{2 D} ( r , {r}_{0} ) = \frac{p}{2 π \vert r - {r}_{0} \vert} \qquad ( 11 )$$

Equation (8) to the function ƒ( ) is to the radiation damage “dpa” per PKA ion flux at a voxel of the 3D representation of the microstructure at location r due to an incident PKA ion originating from a source voxel at r0. “dpa” is the displacement per atom term commonly used in the field as a metric to radiation damage in structural materials due to the displacement of an atom from the material lattice. dpa is commonly used to provide a useful metric of energy deposited in a material by different irradiating means. In this instance the irradiation means is an incident neutron flux on a material producing PKA ions.

In Equation (8) the term y is the array of interfaces between r and r0, and the term T is the amount of ballistic energy per PKA ion deposited into each cell of pre-specified length, l, at location r that can contribute to atomic displacements as determined from the BCA code used and Equations (1) and (2). The word “cell” in the context of the BCA package refers to the calculation elements that the homogenous material is subdivided into for BCA calculation purposes. The term Ed refers to the threshold displacement energy of the PKA ion of energy E. With respect to the voxel of the representation of the microstructure, each voxel is assumed to be a cube of side length, p. Each voxel having an atomic density N and a volume, V.

Undertaking the simulation with the technique, described by way of example at FIGS. 6A to 6D and 5B above, the total number of displacements in a cell of homogenous material is obtained, see the first fraction in Equation (8), from the BCA simulations. Then those results fitted as per Equation (3). This result is then normalised to the size of the voxel of the image representation of the microstructure, and converted to dpa/s by dividing by the number of atoms in each voxel.

FIGS. 5C and 5D are schematic graphs to radiation damage dpa per PKA ion versus PKA energy and penetration depth respectively. The original E(x) reference database values being obtained as described above with respect to Equation (3) and FIG. 5B. Continuing with the analogy of FIGS. 6A and 6B the greater radiation damage in Fe at shallower penetration depths, material 1 of FIG. 6A in comparison to Al can be seen as material 2 of FIG. 5B.

Equation (9) to the source function S( ) is the number of PKA ions generated at the source pixels of the image representation. The number of PKAs produced at each voxel in Equation (9) is the PKA spectrum per atom ¢ (see further below), multiplied by the atomic density N and the volume, V, of the pixel of the image representation.

Equation (10) to the function F3D( ) is the flux fraction of PKA ion flux fraction that reaches the voxel of interest from the source. It is also assumed that the path of the PKA ions from each source is distributed isotropically throughout the material. By a simple conservation argument, the number of ions that a voxel at distance |r−r₀| receives, is the fraction of the surface area a sphere of radius |r−r₀| originating from the source pixel that passes through the voxel of interest (approximated as the voxel face area p2).

In the case of a two dimensional representation of the microstructure, it can be considered as a one voxel thick slice of a 3D representation. If the 2D representation is an image, each voxel is a pixel in the image. Equation (11) to the function F2D( ) is the two-dimensional version of the ion flux fraction that must be used in this case so that PKAs are not lost by leaving the plane of the image. Here a 2D conservation argument is used and the number of ions that a voxel at distance |r−r₀| receives, is the fraction of the circle circumference of radius |r−r₀| originating from the source pixel that passes through the voxel of interest (approximated as the voxel side length p).

In the 2D geometry the PKA ions leaving the image plane due to travelling at some inclination are not properly taken into account. While the loss of PKA ions in the plane are implicitly compensated by PKAs entering from adjacent higher/lower planes, the dpa damage function f( ) of Equation (8) does not take into account the different vertical distances travelled. It also does not consider that the material in the planes above and below the image will be different due to a specific 3D geometry of the phase.

FIG. 5A is a schematic graph of dpa per PKA radiation damage versus depth for a composite, heterogenous material of 20 nm of iron, Fe, overlaying aluminium Al. The incident PKA ion is the same as described above for FIGS. 5B, 5C and 5D to the pure/homogenous materials, as are the determinations of the PKA ion energy with depth according to Equation (3). The damage profile with depth has calculated with the conventional, prior art BCA packages, described in detail further below. The radiation damage was also determined from Equation (8) described herein, by evaluating the f( ) function at each r point for the single PKA species, energy and source r0=0. For this single interface case, Equations (1) and (2), which are present within Equation (8), can be written as

$$R ( E , x ) = {T}_{dam , x} ( ε ( x , 20 ) ) = \{ \begin{matrix}{T}_{dam , Fe} ( {E}_{Fe} ( x ) ) , & x < 20 \\ {T}_{dam , Al} ( {E}_{Al} ( x + a ) ) , & x \geq 20\end{matrix} such that {E}_{Fe} ( 20 ) = {E}_{Al} ( 20 + a ) \qquad ( 12 )$$

FIG. 5A shows that the technique of the invention is in excellent agreement result with the more laborious and computationally intensive BCA codes of the prior art. The slight discontinuity and disagreement at the 20 nm interface between the technique of the invention and the prior art is due to the invention technique of Equation (12) containing a piecewise function that switches between individual damage curves of the pure homogenous Fe and Al materials at the interface rather than treating the structure as a truly continuous material.

This is not the case in the BCA profile, as the collision cascades calculated by the BCA codes travel across the interface continuously, smoothing out the damage curve in the immediate proximity of the 20 nm deep interface. Furthermore, near the interface there are other small discrepancies between the damage profiles as the cascading ions from the overlaying Fe are a different element to Al ion cascades generated in the second material of Al. Accordingly, only in the immediate proximity of the interface, only a few nm, the discrepancy is only to producing different amounts of damage as Fe cascading ions transition through, and backscatter on the interface. As these interfacial cascade Fe ions come to rest in the subsequent phase material of Al, the damage profile returns to being that of the homogenous pure material after the interface, as all the subsequent cascading ions particles are of the same element, in this case aluminium. Referring to FIG. 1 to the microstructure of actual materials, the microstructure is in the order of 10's to 100's of nm, accordingly such minor discrepancies or approximations in the order of a few nm of the interface were not significant.

Further simulation testing with variations to: the interface placed at different depths, different incident PKA energies and ion species, and different material compositions produced similar results. With respect to the analogy of FIGS. 6A to 6D: FIG. 6C conceptually shows the same with material 1 (Fe) sustaining the most radiation damage from the incident PKA ion whilst the underlying material 2 (Al) receives less radiation damage. Interestingly the inventors have noted from FIG. 6C that if a further, deeper layer of iron was in place for the FIG. 5A simulation then the radiation damage would still be greater than that for the intervening aluminium layer. In the following radiation damage profiles for actual microstructures are determined according to the invention.

The novel and inventive technique of the above may be applied to determining the radiation damage profiles of microstructures for materials that may be used in a radiation field. Referring to FIG. 1, this represents the microstructure of a two-phase materials, as may be obtained using microscopy, tomography, diffraction and other characterisation techniques.

The example microstructure images of FIG. 1 may be reduced to representations of the geometry and distribution of the respective phase materials in order to readily identify interfaces between different phase materials during the determination of radiation damage. For example, the images of FIG. 1 is a binarized (black and white) image. Then the radiation damage determinations described above with respect to Equations (2) to (5) may be undertaken on an incremental pixel by pixel basis across the image representation of the microstructure. For example, to FIG. 1 the matrix would be assigned black and the spherical precipitates would be white. It will be readily appreciated that for three or more phases that image representation may also be multiple colours to accommodate radiation damage determinations in further phase materials for a highly heterogenous material.

In contrast, a BCA package can, theoretically, be used to simulate the resultant damage caused by PKA ions moving away from each source pixel to every other pixel, including collision cascades, in the image representation of the microstructure. However, for such a BCA package approach this requires new parameters at each pixel to be determined for at least PKA ion species, PKA ion energies and interface location. This then requires a completely new simulation with a BCA package to be performed for each pixel which may take up to half an hour per pixel to produce good statistics for. For the microstructure image examples with a large number of pixels provided it is apparent that this is not a computationally tractable process useful for the evaluation of the microstructure of heterogenous materials and their multiple interfaces.

It will also be readily appreciated that whilst a pixel by pixel determination has been described herein, the microstructure representations may be in the form of mathematical functions for the geometry and spatial distribution of the phase materials for a microstructure, for example to periodic and aperiodic distributions and various geometries for the precipitate phase. For example, vector graphics may be employed the microstructure representation.

To reduce edge effects for the present examples of FIG. 1, only the radiation damage in a window in the centre of the image representation was determined. Alternatively, if the image region was too small, the microstructure layout was assumed to be the same heterogeneity to the geometry and distribution of the phases throughout the material. In this situation the image flipped and tiled to produce a larger “mosaic” like pattern to reduce edge effects.

As one example, the radiation damage profiles for Fe—NiAl, could then be determined according to the technique described herein with respect to Equations (1) to (5). In the following described example, the initial parameters for the determinations are provided as well as a neutron damage comparison with prior art NRT (see further below) and BCA code models for a validity check of the technique. Then the radiation damage spatial distributions results for the microstructures of the example of Fe—NiAl according to the method of the invention are shown. It will be appreciated that the material Fe—NiAl is being used as an example only, to demonstrate the application of the method for illustrative purposes, and it the application is not limited to such material.

In some cases, the neutron spectra for RPV fission reactor environments are typically in the approximate range of 3×107 to 109 of neutron flux per unit lethargy (ncm-2s-1) to an approximate energy range of 10-2 to 106 eV. The neutron spectra for the proposed DEMO European fusion reactor at the first wall is in the approximate range of 2×1011 to 1013 of neutron flux per unit lethargy (ncm-2s-1) to an approximate energy range of 5×102 to 1013 eV.

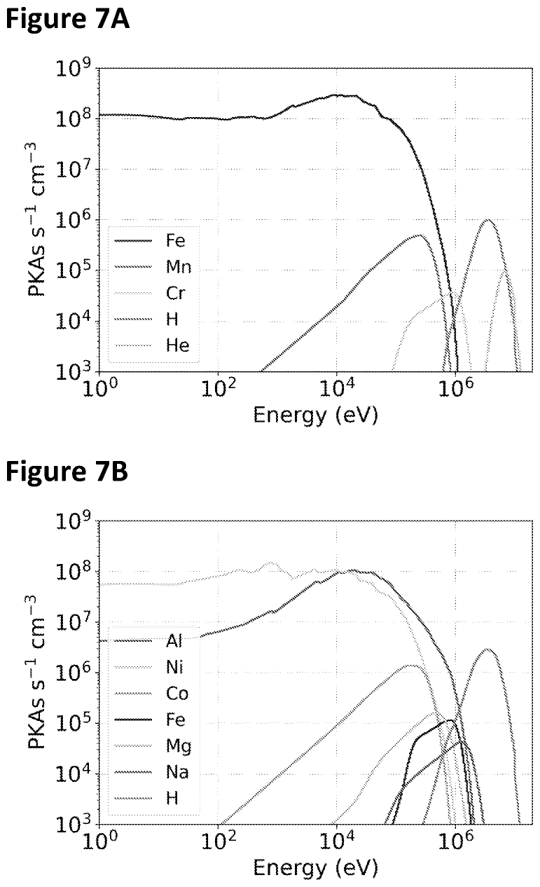

FIGS. 7A and 7B are the calculated PKA ion spectra for the neutron damage to the pure homogeneous materials of each the phases for example materials, Fe—NiAl and W-W2B. The typical neutron spectra of above together with a prior art program SPECTA-PKA, detailed further below, were used to calculate the PKA spectra of FIGS. 7A and 7B. The SPECTRA-PKA package generates PKA flux values in 50 logarithmically spaced bins per magnitude. These can be manually reduced to larger bin sizes to lessen the computational resources as need be.

FIGS. 7A and 7B are the respective PKA ion spectra from the Fe phase and the NiAl phase, each treated as a homogeneous material for the calculation.

The validity of this method to determine the neutron damage generated in a material was checked by using an “empty” image representation (all pixels the same) containing a single phase pure/homogeneous material for a BCA simulation and then compared to the values obtained from the NRT formula (see further below to neutron damage prior art). The neutron damage comparison is shown below in Table 1.

TABLE 1
Neutron damage comparison for NRT and BCA models.

| | Neutron Damage (×10⁻¹⁰ dpa/s) | | | | |
|---|---|---|---|---|---|
| | | BCA | | | |
| | | 2 energies | | 10 energies | |
| Phase | | per | Difference | per | Difference |
| Material | NRT | magnitude | (%) | magnitude | (%) |
| Fe | 3.13 | 3.94 | 26 | 3.74 | 20 |
| NiAl | 2.73 | 3.12 | 14 | 3.09 | 13 |

It can be seen from Table 1 that when comparing the NRT formula to the BCA simulations, the resulting damage can vary by up to 40%. However, this is expected as different interatomic potentials are used in the two formulations, with BCA formulas typically using the Ziegler potential instead of the LSS potential. This difference is not detrimental though as it is well known that dpa is not an absolutely accurate representation of the damage produced. Furthermore, that BCA simulations and NRT calculations overestimate the values obtained when compared to molecular dynamic simulations. The radiation damage dpa instead provides a useful relative metric that can quantify the relative differences between different material phases when the same technique is utilised across a microstructure image representation.

From Table 1, the values obtained from the example are reasonably insensitive to the resolution of the energy bins used in the respective calculations. While an increased resolution of the BCA energy calculation may bring the values slightly more in agreement with the NRT values, it needs to be balanced against increasing the difference by over or under compensating the damage produced for a specific PKA ion energy depending on the formulation of the interatomic potential in the material lattice. To capture an accurate representation of the damage distribution through the pure/homogenous material, the inventors have found that it was sufficient to use a low energy bin resolution (e.g. 1 or 2 energies per magnitude) such that the ranges of PKA penetrations in a material are sufficiently represented.

FIG. 2 is a schematic showing the radiation damage spatial distribution for the material microstructure of FIG. 1. A colour scale is used for the radiation damage in dpa/s in order to increase the clarity and resolution of the radiation damage and spatial distribution across the microstructure. In one example of applying the method to the microstructure of Fe—NiAl, the following observations were noted in respect of the radiation damage spatial distribution:
There is a large variation in radiation damage across the Fe matrix, it may vary by up to 25%
Low radiation damage dpa/s values were concentrated in the secondary phase of NiAl, whilst the higher radiation damage values were concentrated in the Fe matrix
There was not a sudden change in radiation damage at the interfaces between the phases. The blurring of the interfaces between phases indicating that the radiation damage immediately adjacent to the interface between the phases had intermediate values for radiation damage.
The density of the secondary phase of NiAl affected the spatial distribution of the radiation damage. A localised higher proportion of the secondary phase of NiAl (i.e. the spherical precipitates closer together) produced more localised averaging across that region of the microstructure such that the average, localised radiation damage dpa was closer to the dpa of the secondary phase. In the central region of FIG. 2 the lower proportion of the secondary phase compared with the Fe matrix gave a localised higher radiation damage towards that seen for Fe.

The above example shows only some of the advantageous observations found in applying the method to Fe—NiAl, and it will be appreciated that the method may be applied to other materials to reveal different observations. The method is highly material dependent, and so the method will reveal varying observations depending upon the material analysed.

Using the above technique, the inventors have found that different damage rates can affect the evolution of the radiation damage in a heterogenous material and accordingly the associated mechanical properties. The technique can be used to account for the effects of composition, size and shape of the particles in the various phases rather than assuming in engineering design a single homogenous bulk composition. Furthermore, by taking into account the spatial distribution of the microstructure radiation damage, a more informed estimation of the progression radiation damage may be made, and a strategy implemented to increase a materials resistance to radiation damage by changing the microstructural properties such as particle size, shape, distribution, density and composition.

In addition, the inventors have found that the technique is substantially faster and requires substantially less computational resources than the prior art techniques, where the prior art has attempted heterogenous materials simulations. The ability to undertaken more rapid simulations allows for more design scenarios and evaluations to be undertaken in the engineering processes.

Calculating the spatial distribution of damage requires the damage to be deterministically calculated from every pixel in the image, to every other pixel within an inner region of the image. Alternatively, a statistically significant portion of pixels can be selected to perform a stochastic calculation. For performance comparison, we consider the deterministic calculation of an image of 1 μm×1 μm with resolution of 10 nm per pixel, which equates to a 100×100 pixels, with an inner region of interest of 0.5 μm×0.5 μm (50×50 pixel). We consider a typical case where 5 PKA species are produced per material, 10 energies per PKA species are simulated, and each BCA simulation takes approximately 0.5 hrs.

The computational cost of the proposed method is broken into two components: (1) building data library and (2) calculating damage in the image. For (1) the proposed method takes 50 cpu hours to build the BCA data library (2 materials×5 PKA species per material×10 energies per species×0.5 hrs per BCA simulation). For (2), the damage calculation using this data library and Eq. (7) takes in the order of 5e-9 hrs per pixel combination per ion. For the example image, it takes 6.25 cpu hrs to complete the calculation (5e-9 hrs per pixel combination per ion×5 PKAs species per material×10 energies per species×100×100×50×50 pixel combinations). Combining (1) and (2), the total computational time for the proposed method is 56.25 cpu hrs (50+6.25) to calculate the spatial distribution of damage in this image. Subsequent images using the same materials in the same (or similar) radiation environment would only take 6.25 cpu hrs.

In contrast, for a brute force calculation the same image using existing prior art, where a new set of BCA calculations are run for each combination of pixels, the calculation would take 625 million cpu hrs to complete (5 PKA species per material×10 energies per species×100×100×50×50 pixel combinations×0.5 hrs per BCA simulation).

The new technique is orders of magnitude faster than the current alternative. The computational cost of calculating the radiation damage in arbitrary volumes has been reduced by reducing the parameter space of the BCA simulations that need to be run. Simulations need only be run for each PKA species and energy in the pure materials. They do not need to be run for all possible interface permutations that the PKA will encounter. Furthermore, this data is used to create a library that can be reused for later simulations.

Whilst the invention has been described with respect to applications to material subject to radiation, such as in nuclear environments it will be readily appreciated that the technique may be applied to other areas involving the assessment of radiation material to structural and shielding materials. For example, radiation shielding, space applications, radiopharmaceuticals and sterilisation techniques using ionising radiation.

In the following we provide a brief summary of the prior art programs/codes/packages referred to in the above is provided. A brief review of the deficits in these prior art programs in comparison to the invention technique is also given.

### Quantification of Radiation Damage.

Radiation damage is typically measured in displacements per atom (dpa) and can be calculated by the NRT formula in Equation (13) below to produce a useful, standardised reference value for the comparison of different irradiation situations irrespective of the radiation type, flux or target material.

$$K = \frac{0.8}{2 {E}_{d}} σ {T}_{dam} ϕ \qquad ( 13 )$$

where E_{d} is the threshold displacement energy, σ is the nuclear cross section of a given reaction channel, ϕ is the neutron flux and T_{dam} is the damage energy available from the PKA for atomic displacements. Multiplying by exposure time produces a dpa value (Kt) which has become the international standard for the measurement of radiation damage. The Lindhard-Scharff-Schiott (LSS) formula separates the effects of electronic and nuclear collision and is frequently used to calculate T_{dam}.

$${T}_{dam} ( E ) = \frac{E}{1 + {k}_{L} g ( ϵ )} \qquad ( 14 )$$

$${k}_{L} = \frac{32}{3 π} {( \frac{{m}_{2}}{{M}_{2}} )}^{1 / 2} \frac{( {( 1 + {A}_{m} )}^{3 / 2} {Z}_{1}^{2 / 3} {Z}_{2}^{1 / 2} )}{{Z}_{1}^{2 / 3} + {Z}_{2}^{2 / 3}} \qquad ( 15 )$$

$$g ( ϵ ) = ϵ + 0.40244 {ϵ}^{3 / 4} + 3.4008 {ϵ}^{1 / 6} \qquad ( 16 )$$

$$ϵ = \frac{E}{{E}_{L}} \qquad ( 17 )$$

$${E}_{L} = \frac{{Z}_{1} {Z}_{2} {e}^{2}}{{a}_{12}} \frac{1 + {A}_{m}}{{A}_{m}} \qquad ( 18 )$$

$${a}_{12} = {( \frac{9 {π}^{2}}{128} )}^{1 / 3} \frac{{a}_{B}}{{( {Z}_{1}^{2 / 3} + {Z}_{2}^{2 / 3} )}^{1 / 2}} \qquad ( 19 )$$

$${A}_{m} = \frac{{M}_{2}}{{M}_{1}} \qquad ( 20 )$$

Here subscripts 1 and 2 represent the PKA and target material respectively, M is the atomic mass, Am is the atomic mass ratio, Z is the atomic charge, aB(=0.529 177 2 nm) is the Bohr radius, a12 is the Thomas-Fermi screening length, e2(=1.439 965 2 eV nm) is the square of the elementary charge, me (=5.485 799 1×10-4 u) is the electron mass, EL is the LSS energy, E is the reduced LSS energy and kL is the LSS electronic stopping parameter.

While the NRT formula provides a useful metric for radiation damage, it does not take into account thermal effects, the recombination of defects, the formation of extended defects such as loops, clusters and sinks, or the creation of precipitates. It is also known to overestimate the number of stable defects and underestimate the amount of atomic mixing that takes place. Furthermore, nothing in the model allows for the microstructure of the material to be considered. These equations model the material as an amorphous solid of homogeneous and isotropic composition, with no mechanism to include multiple different materials separated by an interface. Currently, the only method of accounting for heterogeneity in the primary radiation damage calculations is to treat each phase separately in isolation. However, treating the phases separately does not give a complete picture of the material as the damage is not segregated by the phases. Instead PKAs and cascade particles from one phase can enter and damage a neighbouring phase and vice versa.

### Neutron Damage Calculations.

Calculating the neutron radiation damage incurred by a material using the NRT and LSS formalism is a long process for multi-isotopic materials and multi-energy fluxes as all reaction channels for all isotopes at all energies need to be included. Computer programs have hence been developed to perform these calculations. One example of such program is SPECTRA-PKA which is able to process modern nuclear data files and complex material compositions.

Using multi-group cross section files from available databases, neutron damage calculation packages such as SPECTRA-PKA read the n possible PKA energies E_{PKA}ⁿ, neutron cross section σ_{ab}(Eᵢ), and probability P_{ab}(E_{PKA}ⁿ,Eᵢ) of producing a daughter PKA with energy E_{PKA}ⁿ as a function of the incident neutron energy E_i (the differential cross section converted from angle to energy). Subscripts a and b here indicate the target and daughter nuclides respectively. A cross section vector mₙᵢ^{ab}, Equation (21) below, of the total probability for a recoil is calculated and the NRT formula applied using a calculated LSS damage energy T_{dam}^{b} (E_{PKA}ⁿ) and given flux ϕ(Eᵢ) to find the dpa rate per reaction channel as shown in Equation (22) below.

$${m}_{ni}^{ab} = {σ}_{ab} ( {E}_{i} ) {P}_{ab} ( {E}_{PKA}^{n} , {E}_{i} ) \qquad ( 21 )$$

$${K}_{ab} = \frac{0.8}{2 {E}_{d}} {\sum }_{i} ϕ ( {E}_{i} ) {\sum }_{n} {m}_{ni}^{ab} {T}_{dam}^{b} ( {E}_{PKA}^{n} ) \qquad ( 22 )$$

A summation over all b reactions results in the dpa rate per target atom, and a further summation over all targets a weighted by the atomic concentration gives the total dpa rate of the material. As the energy spectra are provided in discrete bins, interpolation and averaging of the energy bins is required to match the flux to the cross section and damage energy bins. The accuracy of these numbers in relation to the actual radiation damage is of course limited by the limitations of the NRT model previously discussed. These calculations also do not consider the microstructure of the material such as precipitates or grain boundaries, or the macroscopic structure such as shape or layered materials. Furthermore, the direction of the flux is not considered, and the resulting structure of the crystal lattice not produced.

### Binary Collision Approximation (BCA) Models.

In a BCA model, the incident ion is approximated as a particle travelling through a material in a sequence of independent collision with the target nuclei. Between collisions, the path of the ion is assumed to be a straight line, with the ion losing energy via electronic stopping. Each collision interaction is treated like a classical two body scattering problem. The energy loss and scattering angle (and hence trajectory) of the incident ion after the collision is calculated by solving the classical scattering integral between the incident ion and a single nucleus as a result of an interatomic potential.

BCA model packages utilise a Monte Carlo approach to calculate the ion passage and deposition in the material. The mean free path distance and impact parameter of the ion in a material is randomly selected from a probability distribution that is only dependent on the target material density. When many iterations are calculated this is equivalent to calculating the ion path distribution in an amorphous sample. BCA models normally include the functionality of simulating layers of differing composition, allowing simulation of the particle traversing simple, planar interfaces.

At low energies the BCA approximation of independent collisions between the ion and target particle begins to break down, and completely fails under approximately 1 keV. At these low ion energies, Molecular Dynamics codes are used instead as they are designed to solve arbitrarily large multi-body collisions. Molecular Dynamics codes have the added benefit of accounting for thermal effects, time dependence, recombination of interstitial and vacancy defects, and the formation of clusters and sinks. They generally provide a more realistic picture of radiation damage incurred by the target and more closely match experimental observations. However, Molecular Dynamics simulations are significantly more computationally expensive to run than BCA packages.

As previously discussed, the NRT dpa is used in the industry as a standardised reference value for radiation damage. In BCA modelling software this can be calculated using either the total number of vacancies produced, or the energy dissipated to the target. There are two basic options for calculating these values. They are the “Ion Distribution and Quick Calculation of Damage” (Quick K-P) option which just follows the incident ions, and “Detailed Calculation with Full Damage Cascade” (Full Cascade) which follows the cascade particles as well. Stoller et al. compared the dpa values obtained using these methods in SRIM. We refer to:

R. Stoller, M. Toloczko, G. Was, A. Certain, S. Dwaraknath, and F. Garner, “On the use of SRIM for computing radiation damage exposure”. Nuclear Instruments and Methods in Physics Research Section B: Beam Interactions with Materials and Atoms, 310 (2013) 75-80. doi: 10.1016/j.nimb.2013.05.008; the contents of which are incorporated herein by reference. Stoller found that the dpa calculated using vacancies from the Full Cascade option was over a factor of two greater than those obtained from the equivalent Quick K-P calculation and the NRT formula. When the damage energy was used instead, the values were approximately the same. As a given damage energy should produce the same number of displacements, this indicates that there is a problem in the implementation of the Full Cascade option in SRIM, however its cause is unknown due to SRIM being closed source. Despite the nomenclature implying that the Full Cascade option is more accurate, and the SRIM manual explicitly recommending that the Full Cascade option be used, Stoller presents an alternate method for the calculation of dpa, reproduced below.
1. Run SRIM using the “Ion Distribution and Quick Calculation of Damage” option,
2. Choose the recommended displacement energy from the ASTM standards,
3. Set the lattice binding energy to 0,
4. Compute the damage energy using the energy lost to phonons,
5. Use this damage energy in the NRT formula to calculate the dpa.

Recent research by Crocombette and Wambeke has shown that the use of the Quick K-P simulation option cannot be applied to multi-elemental materials. We refer to: J.-P. Crocombette and C. V. Wambeke, “Quick calculation of damage for ion irradiation: implementation in Iradina and comparisons to SRIM”. EPJ Nuclear Sciences & Technologies, 5 (2019) 7. doi: 10.1051/epjn/2019003; the contents of which are incorporated herein by reference. Using IRADINA, Crocombette showed that the relative amount of displacements for multi-elemental materials such as UO₂ produced unreasonable physical results. Using Quick K-P, the amount of displaced U atoms approximately equalled the amount of displaced oxygen atoms, despite there being twice as many oxygen atoms. They also note that neither the SRIM instruction manual nor Stoller of above suggested using the Quick K-P option for complex materials. Instead Crocombette suggested to use the Full Cascade simulation option, followed by using steps 2-5 of Stoller's method above to calculate the displacements from the deposited ballistic energy.

Although the invention has been herein shown and described in what is conceived to be the most practical and preferred embodiments, it is recognised that departures can be made within the scope of the invention, which are not to be limited to the details described herein but are to be accorded the full scope of the appended claims so as to embrace any and all equivalent assemblies, devices, apparatus, articles, compositions, methods, processes and techniques. Furthermore, any formulas given above are merely representative of procedures and techniques that may be used

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises” where they appear.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. Functionality may be added or deleted from the block diagrams and operations may be interchanged among functional blocks. Steps may be added or deleted to methods described within the scope of the present invention.

1. A method for determining a spatial distribution of a radiation damage of a heterogenous material, including the steps of:
representing a geometry and a distribution of a multiphase microstructure of the heterogenous material as an image;
determine a first energy of a PKA ion at a first interface at a first distance from an incident PKA ion to a first phase material of the microstructure image representation;
use the first energy at the first interface between the first phase material and an adjacent second phase material to determine a second PKA energy at a second interface to a further phase material at a second distance from the first interface;
use the second energy at the second interface to determine a further PKA ion energy in the further phase material; and
repeat the steps for further interfaces and further phase materials across the microstructure image representation;
wherein the further phase materials are at least one of: the same as the prior phase material/s and different to the prior phase material/s; and
wherein the radiation damage in the heterogenous material is determined from the PKA ion energy deposited in each phase material;
whereby the spatial distribution of the radiation damage across the microstructure image representation is determined.

2. A method according to claim 1, wherein the energy of a PKA ion is determined using the equation:
$$E ( x ) = \{ \begin{matrix}{E}_{0} - mx , & E ( x ) > ϵ \\ {A ( d - x )}^{\frac{1}{c}} , & E ( x ) \leq ϵ\end{matrix} .$$

3. A method according to claim 2, wherein m is defined as
$$m = \frac{{E}_{0} - ϵ}{d - {( \frac{ϵ}{A} )}^{c}} .$$

4. A method according to claim 2 or claim 3 wherein A is defined as
$$A = {[ \frac{{ϵ}^{c} + c {ϵ}^{c - 1} ( {E}_{0} - ϵ )}{d} ]}^{\frac{1}{c}} .$$

5. A method according to claim 4 wherein
$$A = \frac{{E}_{0}}{{d}^{\frac{1}{c}}} if ϵ = {E}_{0} .$$

6. A method according to claim 1 wherein the microstructure image representation is in 3D voxels or 2D pixels and the determinations to PKA ion energies and interfaces are made voxel by voxel, or pixel by pixel.

7. A method according to claim 1, wherein the step of representing a geometry and a distribution of a multiphase microstructure further includes multiple images to determine a three dimensional spatial distribution of radiation damage.

8. A method according to claim 1, wherein the microstructure geometries are in the order of the longest-range PKA produced by the material in the radiation field.

9. A method according to claim 1 wherein the geometry and the distribution of a multiphase microstructure are derived from an actual heterogenous material.

10. A method according to claim 1, wherein the geometry and the distribution of a multiphase microstructure are hypothesised for any arbitrary hypothetical material.

11. A method according to claim 1, wherein the spatial distribution of radiation damage is calculated deterministically or stochastically.

12. A method for determining a spatial distribution of a radiation damage of a heterogenous material, including the steps of:
representing a geometry and a distribution of a multiphase microstructure of the heterogenous material as an image;
determine the energy spectrum of PKA ions at a first interface at a first distance from an incident PKA ion to a first phase material of the microstructure image representation;
use the first energy spectrum at the first interface between the first phase material and an adjacent second phase material to determine a second PKA energy spectrum at a second interface to a further phase material at a second distance from the first interface;
use the second energy at the second interface to determine a further PKA ion energy spectrum in the further phase material; and
repeat the steps for further interfaces and further phase materials across the microstructure image representation;
wherein the further phase materials are at least one of: the same as the prior phase material/s and different to the prior phase material/s; and
wherein the radiation damage in the heterogenous material is determined from the PKA ion energy deposited in each phase material;
whereby the spatial distribution of the radiation damage across the microstructure image representation is determined.

13. A radiation damage spatial distribution of a microstructure according to the method of any one of claims 1 to 11.

14. A material property of a microstructure as derived from a radiation damage spatial distribution according to the method of any one of claims 1 to 11.

15. A strategy to reduce radiation damage to material, or increase material resistance to radiation damage, derived from the spatial distribution of radiation damage according to the method of any one of claims 1 to 11.
